(19) United States
(12) Patent Application Publication
(10) Pub. No.: US 2007/0088667 A1
(43) Pub. Date: Apr. 19, 2007

(54) Systems and methods for data processing

(76) Inventors: Thomas Schwarz, Edingen-Neckarhausen (DE); Robert Reginek, Walldorf (DE); Chalbia Abdelfattah, Walldorf (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/248,131

(22) Filed: Oct. 13, 2005

(51) Int. Cl. G06F 17/30

(52) U.S. Cl. 707/1

(57) ABSTRACT

Systems and methods are provided for data processing. In one implementation, a method extracts first data and second data from an online transactional processing module using an online analytical processing module. The first data is descriptive of past account transactions and the second data is descriptive of a rule that identifies a sub-set of a set of accounts for which account specific data processing actions are required. The rule is applied to the first data to identify the sub-set of accounts and the respective account specific data processing actions. Further, a database table is generated that identifies the sub-set of accounts and specifies the respective account specific data processing actions. The database table is read by the online transactional processing module and the account specific data processing actions specified in the database table are executed by the online transactional processing module.

### BACKGROUND

I. Technical Field

The present invention generally relates to software and the field of data processing. More particularly, the invention relates to systems and methods for online transactional processing and online analytical processing.

II. Background Information

Online transactional processing (OLTP) is a commonly used in various industries, including banking. For example, an account management system at a bank can be implemented using OLTP technologies. Additionally, OLTPs are often used to perform so-called mass activities. A mass activity is a data processing procedure that involves the processing of a large class of data records, such as a large class of customer accounts. A common disadvantage of conventional OLTPs, however, is that the selection of the data records, the specification of the data processing process to be executed, and/or the scheduling of mass activities is not fully automated and requires manual user interaction.

Online analytical processing (OLAP) technology is also used in various industries and allows for multi-dimensional analysis of data such that results can be supported in a manner consistent with explaining their significance or interrelationships. OLAP is often based upon the use of multi-dimensional data structures and aggregated data to ensure acceptable performance in liberating the technology. In contrast to OLTP, OLAP focuses on supporting analysis versus the support of operational systems. However, OLAP modules, like OLTP modules, also require some degree of manual user interaction for the specification of the data processing actions to be executed. Therefore, there is a need for more efficient systems and methods for processing data such that manual user interaction is not required.

### SUMMARY

In accordance with an embodiment of the present invention, a data processing system is provided. The data processing system comprises an online transactional processing module including a data processing unit for execution of data processing actions for a set of accounts and a storage unit for storing first data descriptive of past account transactions and second data descriptive of at least one rule for identification of a sub-set of the accounts for which account specific data processing actions are required. An online analytical processing module may also be provided that includes an extractor for extracting the first data and the second data from the online transactional processing module. An analytical processing component applies the at least one rule to the first data for identification of the sub-set of accounts and the respective account specific data processing actions and may be adapted to generate a database table for identification of the sub-set of accounts and the respective account specific data processing actions. Further, the online transactional processing module may be adapted to read the database table and to execute the respective account specific data processing actions.

In accordance with one embodiment of the invention, the first data also contains account master data, customizing data, action status data, and/or other data of various origins.

In accordance with another embodiment of the invention, the second data contains a set of all rules that specify data processing actions.

Consistent with embodiments of the present invention, execution of account specific data processing actions may be facilitated by an OLTP module. This may be accomplished by extracting at least data descriptive of past account transactions and data descriptive of at least one rule from the OLTP module to the OLAP module. Further, the OLAP module may apply the at least one rule to the data that describes the past account transactions in order to identify respective account specific data processing actions that need to be executed, if any. Such account specific data processing actions are specified in a database table by the OLAP module. The content of this database table may be read by the OLTP module for execution of the specified account specific data processing actions. Therefore, an OLAP module may be used for automatic specification or identification of account specific data processing actions to be performed by an OLTP module without the need for any manual user interaction.

In accordance with one embodiment of the present invention, the OLTP module may comprise a plurality of mass activity nodes. For example, the OLTP module may include a data processing unit that comprises a plurality of processing units, such as processing blades or another parallel processing architecture. Each of the processors may provide one or more of the mass activity nodes for parallel processing of blocks of the specified mass activity. The mass activity nodes may read respective blocks of the database table from the OLAP module for execution of the respective data processing actions specified in the table.

In accordance with an embodiment of the present invention, data that is at least descriptive of latest customer-initiated transaction dates may be extracted from the OLTP module by the OLAP module. For example, the dates of the latest customer-initiated transactions may be stored in a separate database table by the OLTP module, such as customer initiated-monetary-transactions (CIMT). Further, each time a customer-initiated transaction is successfully posted by the OLTP module, the latest customer-initiated transaction date may be updated.

In accordance with another embodiment of the present invention, the at least one rule that is applied by the OLAP module serves to identify a status transition by evaluation of the past account transactions or latest customer-initiated transaction dates. For example, each account that is maintained by the OLTP module may have one of the following four account states: active, inactive, dormant or abandoned. For example, rules are identified that lead to data processing actions when applied to the first data that has been extracted.

In accordance with an embodiment of the present invention, the rules and account states correspond to the applicable statutory regulations of unclaimed property law. In some countries businesses, in particular banks, that hold unclaimed property are required to file annual reports and remit the property to the state. In the United States, this is regulated by the Uniform Unclaimed Property Act of 1995 (UUPA). Different U.S. states have adopted different versions of the Uniform Act. Embodiments of the present invention may facilitate automated compliance with the applicable unclaimed property legislation.

Furthermore, the UUPA outlines specific requirements regarding the handling and reporting of unclaimed property, in particular dormancy and escheat procedures. In essence, a bank has to identify those of its customers to which it has lost contact. Accounts of such customers can be identified as abandoned or dormant accounts depending on the date of the last customer-initiated or bank-initiated contact. Banks can also identify customer accounts for which there has not been any customer-initiated transaction, like a withdrawal, for a specified period of time. Such accounts can be identified as inactive. The time period for the respective state transitions, such as from active to inactive, dormant or abandoned can be defined by the applicable regulatory provisions. In the absence of such regulatory provisions, or as an addition to such regulatory provisions, a bank can specify its own respective status transition rules which can also be product or property type specific.

In accordance with one embodiment of the present invention, the OLTP module automatically generates a customer notification or warning letter to a customer if a status transition of this customer's account has been identified. For example, such a warning letter is generated when the account status transitions from active to inactive in order to pre-warn the customer that the account may become dormant. This can be specified in the customizing.

In accordance with another embodiment of the present invention, the OLTP module automatically escheats abandoned accounts and initiates the transfer of the respective funds to the state treasury.

In accordance with an embodiment of the present invention, the database table that is generated by the OLAP module for identification of the accounts and respective account specific data processing actions, such as state transitions, is implemented as an operational data store (ODS) object. An ODS object can be implemented as an integral part of the SAP Business Information Warehouse (SAP BW), commercially available from SAP AG (Walldorf, Germany). Alternatively, or in addition, the database table may be stored as an InfoCube, or Master Data Table. The ODS is used to store data that identifies the accounts for which data processing actions are required, such as state transitions, in relational database tables.

In accordance with another embodiment of the present invention, the OLTP module provides an acknowledgement signal to the OLAP module after completion of all data processing actions that are specified in the ODS object that has been generated by the OLAP module. Preferably, the OLAP module will only initiate a subsequent processing chain after the acknowledgement signal has been received.

In accordance with an embodiment of the present invention, the OLAP module comprises a scheduler for scheduling the initiation of the processing chain, such as a process from data extraction until receipt of the acknowledgement signal from the OLTP module. Preferably, the scheduler initiates the performance of the processing chain when the transactional data processing load of the OLTP is relatively low, such as nightly.

Consistent with embodiments of the present invention, complete processing of all accounts can be split up into a number of parallel or sequential processing chains by the scheduler. For example, the complete set of accounts that are handled by the OLTP module is split into a number of X sub-sets i, where 0<i <X. Each time the scheduler initiates the execution of a process chain only one of the sub-sets i is processed, i.e. only the data that relates to that sub-set is extracted by the OLAP and analyzed. Therefore, if processing is initiated nightly by the scheduler, a number of X days is required for a complete review of all accounts handled by the OLTP module.

In another embodiment of the present invention, a data processing method extracts first data and second data from an online transactional processing module by an online analytical processing module. The first data may be descriptive of past account transactions and the second data is descriptive of at least one rule for identification of a sub-set of a set of accounts for which account specific data processing actions are required. The at least one rule is applied to the first data for identification of the sub-set of accounts and the respective account specific data processing actions. A database table is generated for identification of the sub-set of accounts and for specification of the respective account specific data processing actions. The database table is read by the online transactional processing module. The account specific data processing actions specified in the database table are executed by the online transactional processing module.

Consistent with another embodiment of the present invention, a computer program product performs the above-described data processing method.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary data processing system, consistent with an embodiment of the present invention;

FIG. 2 is a flowchart of an exemplary method, consistent with an embodiment of the present invention; and

FIG. 3 is a block diagram of another exemplary data processing system, consistent with an embodiment of the present invention.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

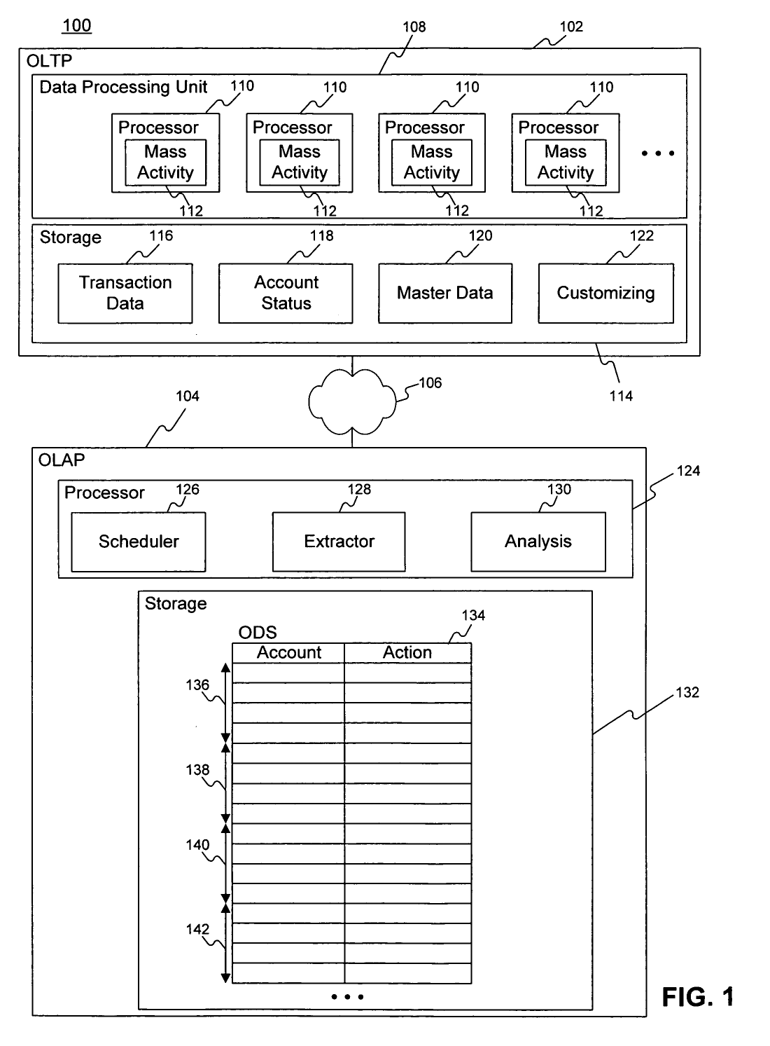

FIG. 1 shows an exemplary data processing system 100 that comprises an OLTP module 102 and an OLAP module 104. OLAP module 104 can be coupled to the OLTP module 102 by a network 106. OLTP module 102 can be constituted by one, two or more separate OLTP sub-modules that can be interconnected by the network 106 or another network in order to form OLTP module 102.

OLTP module 102 includes a data processing unit 108. In the embodiment considered in this example, data processing unit 108 includes a parallel processor architecture including a plurality of processors 110. For example, data processing unit 108 can be implemented by means of blade computing technology, whereby each blade has one processor 110.

Data processing unit 108 serves to execute various types of data processing tasks including so-called mass activities. Preferably, execution of a mass activity 112 is parallelized using some or all of processors 110 of data processing unit 108. For example, each processor 110 constitutes a mass activity node for performance of its portion of mass activity 112.

Further, OLTP module 102 includes a storage component 114 for storing a database 116 that includes transaction data. For example, OLTP module 102 implements a so-called account management system of a bank. In this example, database 116 stores data descriptive of past account transactions, such as transaction postings.

A database table 118 stores account status information. For example, for each account that is managed by the account management system, respective status information is given in database table 118. For example, each account can have one of the following states: active, inactive, dormant, or abandoned. Other states can be defined in the customizing process.

A database 120 of OLTP module 102 holds master data, such as customers'names, addresses, and birthdays. The account status information can also be stored as part of the master data.

Customizing data 122 is stored in storage component 114 and comprises at least one rule that specifies conditions for the identification of accounts for which account specific data processing actions are required. For example, customizing data 122 comprises one or more rules that serve for identification of such accounts that require a status transition or customer notification. In one application, the one or more rules contained in customizing data 122 reflect the regulatory requirements regarding unclaimed property, such as dormancy and escheat processing.

OLAP module 104 includes at least one processor 124 for execution of a scheduler 126, an extractor 128, and an analytical program component 130. Scheduler 126 initiates a process chain. Preferably, scheduler 126 initiates execution of a process chain when the load of OLTP module 102 is relatively low. The current load situation of OLTP module 102 can be reported from OLTP module 102 to OLAP module 104 such that scheduler 126 can determine suitable points of time to initiate execution of the process chain. Alternatively, or in addition, scheduling is pre-programmed. For example, scheduler 126 may be programmed to initiate the execution of a process chain nightly. As a further alternative, scheduler 126 may be manually preprogrammed.

Extractor 128 extracts data from storage 114 that is required for application of the at least one rule by analytical program component 130. Further, OLAP module 104 includes a storage component 132 for storing an ODS object. The ODS object contains a database table 134 that identifies certain accounts and specifies required account-specific data processing actions, such as status transitions or other actions.

In operation, scheduler 126 initiates the execution of a process chain. First, scheduler 126 invokes extractor 128, which extracts transaction data, account status data, master data, and customizing data from storage component 114. After the data has been extracted via network 106, analytical program component 130 is invoked and applies the at least one rule that has been obtained from customizing data 122 to the transaction and account status data. For example, extractor 128 extracts a complete copy of the transaction, account status, and master data. Alternatively, the at least one rule is extracted first in order to determine the data stored in the OLTP module that is required to apply the at least one rule. The data is then extracted in a second extraction step.

For dormancy and escheat processing, the master data, such as a customer's address, is required to determine the rule that will implement the applicable state law legislation.

When analytical program component 130 identifies an account that fulfills the conditions of an applicable rule, analytical program component 130 enters the respective account number into database table 134. Analytical program component 130 also enters into database table 134 a specifier of a respective account-specific data processing action as given by the applicable rule. After execution of analytical program component 130, database table 134 contains the account numbers for which respective account-specific data processing actions, such as state transitions, are required.

Next, OLAP module 104 sends a trigger signal to OLTP module 102 to initiate processing of database table 134 by OLTP module 102. In response, OLTP module 102 reads database table 134 and performs the account specific data processing actions as specified in database table 134. After execution of all data processing actions specified in database table 134 by data processing unit 108 of OLTP module 102, OLTP module 102 returns an acknowledgement signal to OLAP module 104, which ends the processing chain. Alternatively, OLTP module 102 is called asynchronously and OLAP module 104 stops the process chain without waiting for an acknowledgement from OLTP module 102. OLTP module 102 also erases the transmitted triggers in database table 134, which constitutes the signal for enabling a consecutive process chain, such as on the next day. This enables scheduler 126 to initiate a subsequent processing chain at a scheduled later point of time.

Preferably, processing of database table 134 is performed by mass activity 112. In this example, database table 134 can be split into blocks 136,138, 140, and 142, where each of these blocks may be processed by one of the mass activity nodes constituted in data processing unit 108.

It is to be noted that processing of all accounts managed by OLTP module 102 can be split up into multiple process chains. For example, a complete review of accounts is performed by means of a number of X consecutive process chains. In this example, data that is extracted from storage 114 can be limited to the respective sub-set of accounts that are scheduled for processing in the current process chain.

The actions that are specified in database table 134 can comprise status transitions of accounts and/or other actions, such as sending a warning letter or notification to a customer regarding an imminent or a completed status transition of the customer's accounts, the generation of reporting documents to fulfill respective regulatory reporting requirements, and/or the transfer of escheated property to the state treasury.

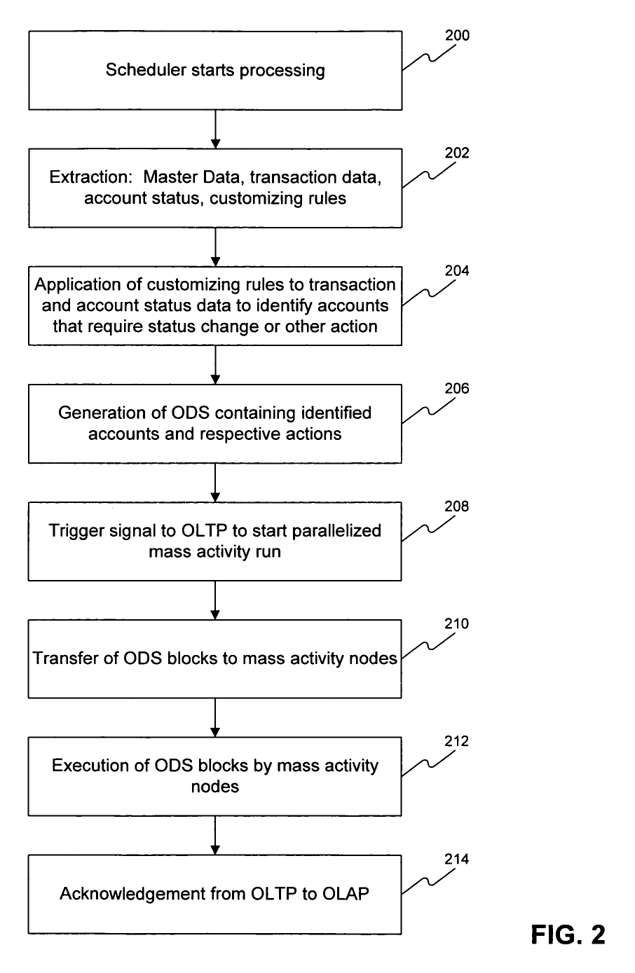

FIG. 2 shows a flowchart for an exemplary mode of operation of a data processing system, such as the system 100 shown in FIG. 1. In step 200, scheduler 126 starts a processing chain at a scheduled point in time. In step 202, scheduler 126 invokes extractor 128, which extracts transaction data, accounts status data, master data, and customizing data, including customizing rules. Customizing rules specify conditions which, when fulfilled by an account, require execution of a certain data processing action with respect to that account. Examples of data processing actions include a status transition for dormancy and escheat processing.

In step 204, the customizing rules are applied to the extracted account related data to identify accounts that require a data processing action, such as a status change or other kind of action. In step 206, an ODS object is generated or filled that contains the accounts that have been identified by means of the applicable rule or rules and the respective actions.

Next, in step 208, a trigger signal is sent from OLAP module 104 to OLTP module 102 to start a parallel mass activity run for processing of the ODS object that has been generated or filled with data in step 206. In step 210, blocks of the ODS object are transferred to respective mass activity nodes. In step 210, the ODS blocks are processed and the specified actions are executed by the respective mass activity nodes. After execution of actions that are specified in the ODS object, in step 214, OLTP module 102 sends an acknowledgement signal to OLAP module 104. In response, the ODS data is erased.

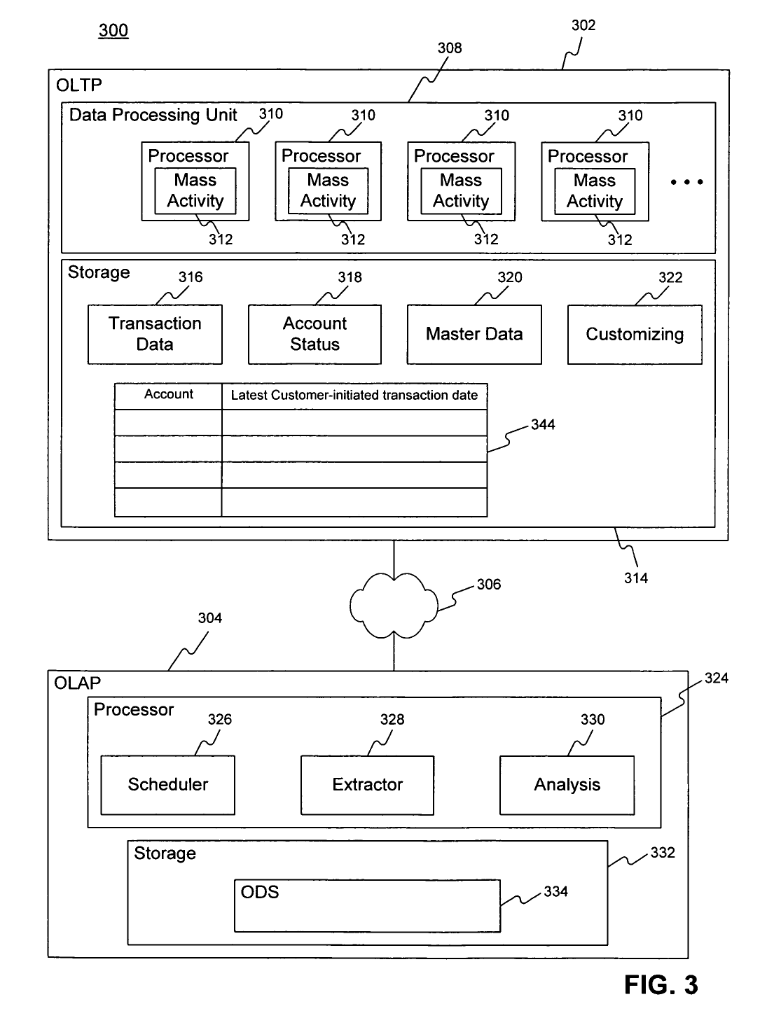

FIG. 3 shows another embodiment of an exemplary data processing system, consistent with an embodiment of the present invention. Elements in the embodiment of FIG. 3 that correspond to elements in the embodiment of FIG. 1 are designated by like reference numerals (e.g., network 106 in FIG. 1 is similar to network 306 in FIG. 3).

As shown in FIG. 3, an OLTP module 302 includes an additional database table 344 that stores the latest customer-initiated transaction date for each account managed by OLTP module 302. Each time a customer-initiated transaction has been successfully posted in a database 316, the latest customer-initiated transaction date is updated in database table 344. As a result, the amount of data that needs to be extracted and transferred from OLTP module 302 to OLAP module 304 is limited. For example, an extractor 328 only extracts database table 344, the accounts status data, master data, and customizing data, but not the complete transaction data. Execution of an analytical program component 330 may thus be sped up, as well as overall execution time of the process chain.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets or in SAP R/3 or ABAP. One or more of such software sections or modules can be integrated into a computer system or existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A data processing system, comprising:
an online transactional processing module, comprising:
a data processing unit for executing data processing actions for a set of accounts; and
a storage unit for storing first data descriptive of past account transactions and second data descriptive of at least one rule for identification of a sub-set of the accounts for which account specific data processing actions are required; and
an online analytical processing module, comprising:
an extractor for extracting the first data and the second data from the online transactional processing module; and
an analytical processing component for applying the at least one rule to the first data to identify the sub-set of accounts and the respective account specific data processing actions, wherein the analytical processing component is adapted to generate a database table that identifies the sub-set of accounts and the respective account specific data processing actions,
wherein the online transactional processing module reads the database table and executes the respective account specific data processing actions.

2. The data processing system of claim 1, wherein the data processing unit comprises a plurality of mass activity nodes and the database table is read in blocks that are processed by the plurality of mass activity nodes.

3. The data processing system of claim 1, wherein the first data is descriptive of latest customer-initiated transaction dates and the first data is updated when the customer-initiated transaction is successfully posted by the online transactional processing module.

4. The data processing system of claim 1, wherein the at least one rule identifies a status transition from a first account status to a second account status and the respective account specific data processing action updates an account status of one of the accounts.

5. The data processing system of claim 4, wherein the account status is selected from a group consisting of active, inactive, dormant, and abandoned.

6. The data processing system of claim 4, wherein one of the data processing actions generates a warning letter to a customer when a status transition occurs.

7. The data processing system of claim 1, wherein one of the data processing actions escheats abandoned accounts.

8. The data processing system of claim 1, wherein the database table is comprised in an operational data store object.

9. The data processing system of claim 1, wherein the online transactional processing module provides an acknowledgement signal to the online analytical processing module after completion of account specific data processing identified in the database table.

10. The data processing system of claim 1, further comprising a scheduler that schedules processing of the first data.

11. The data processing system of claim 10, wherein the scheduler divides the first data in portions that are scheduled for processing at consecutive time intervals.

12. A data processing method, comprising:
extracting first data and second data from an online transactional processing module using an online analytical processing module, wherein the first data is descriptive of past account transactions and the second data is descriptive of at least one rule that identifies a sub-set of a set of accounts for which account specific data processing actions are required;
applying the at least one rule to the first data to identify the sub-set of accounts and the respective account specific data processing actions;
generating a database table that identifies the sub-set of accounts and specifies the respective account specific data processing actions;
reading the database table by the online transactional processing module; and
executing the account specific data processing actions specified in the database table by the online transactional processing module.

13. The data processing method of claim 12, wherein the database table is read in blocks that are processed by respective mass activity nodes of the online transactional processing module.

14. The data processing method of claim 12, wherein the first data is descriptive of latest customer-initiated transaction dates, and wherein the method further comprises updating the first data each time a customer-initiated transaction is successfully posted by the online transactional processing module.

15. The data processing method of claim 12, wherein a status transition from a first to a second account status is detected by application of the at least one rule with respect to at least one account of the sub-set of accounts and wherein the method further comprises specifying a respective account specific data processing action for updating the account status.

16. The data processing method of claim 15, the account status being selected from a group consisting of active, inactive, dormant, and abandoned.

17. The data processing method of claim 16, wherein one of the account specific data processing actions specifies to escheat the respective account if the account status of that account is abandoned.

18. The data processing method of claim 12, further comprising dividing the first data in portions by a scheduler of the online analytical processing module for application of the at least one rule to portions of the first data at consecutive time intervals.

19. A computer program product comprising computer executable instructions for performing a data processing method, the data processing method comprising the steps of:
extracting first data and second data from an online transactional processing module using an online analytical processing module, the first data being descriptive of past account transactions and the second data being descriptive of at least one rule that identifies a sub-set of a set of accounts for which account specific data processing actions are required;
applying the at least one rule to the first data to identify the sub-set of accounts and the respective account specific data processing actions;
generating a database table that identifies the sub-set of accounts and specifies the respective account specific data processing actions;
reading the database table by the online transactional processing module; and
executing the account specific data processing actions specified in the database table by the online transactional processing module.
